(19) United States
(12) Patent Application Publication
(10) Pub. No.: US 2004/0210522 A1
(43) Pub. Date: Oct. 21, 2004

(54) Charging gateway component selection of billing system component to handle charging data record based on one or more characteristics of the charging data record

(76) Inventors: Annette S. Bissantz, Carol Stream, IL (US); David C. Harms, West Chicago, IL (US); Catherine M. Scott, Sugar Grove, IL (US); Ariel Sharon, Naperville, IL (US)

Correspondence Address: PATTI & BRILL, ONE NORTH LASALLE STREET, 44TH FLOOR, CHICAGO, IL, 60602, US

(21) Appl. No.: 10/407,286

(22) Filed: Apr. 4, 2003

(51) Int. Cl. G06F 17/60

(52) U.S. Cl. 705/40; 705/39

(57) ABSTRACT

A charging gateway component of an apparatus in one example selects a billing system component, to handle a charging data record, from a plurality of available billing system components based on one or more characteristics of the charging data record.

### TECHNICAL FIELD

The invention relates generally to communications and more particularly to billing in communication systems.

### BACKGROUND

In one configuration of a billing system in a communications system, charging data records (“CDRs”) are generated at a particular data node and processed by a billing system component. A charging gateway facility (“CGF”) forwards the charging data records from the particular data node to one billing system component that is associated with that charging gateway facility. The one billing system component is designated to process all of the charging data records from the respective charging gateway facility.

The generation of a charging data record occurs at a data node in response to a billable event. For example, the billable event comprises a data transfer that involves a user of the communications system. In one example, the data node comprises a serving general packet radio service support node (“SGSN”) or a gateway general packet radio service support node (“GGSN”).

The charging data record comprises billing information from the data transfer for which the charging data record was generated. For example, the charging data record comprises an indication of a quantity of data transferred and/or a time duration of the data transfer. The data node closes the charging data record upon occurrence of a closure event for the charging data record. For example, data node closes the charging data record once a predetermined quantity of data has been transferred and/or a predetermined time duration of the data transfer has been reached.

Upon closing the charging data record, the data node sends the charging data record to the charging gateway facility. The charging gateway facility routes the charging data record to the one billing system component which is associated with that charging gateway facility. Some charging data records require a specific processing service. For example, some charging data records require faster (e.g., near real-time) processing and/or processing customized for a specific data node and/or user. As one shortcoming, the one particular billing system component associated with a charging gateway facility in one example lacks a specific processing service suited for charging data records from a data node associated with that charging gateway facility.

Thus, a need exists for enhanced availability of a processing service of increased suitability for a charging data record. A further need exists for increased selectability of a processing service appropriate for a charging data record

### SUMMARY

The invention in one embodiment encompasses an apparatus. The apparatus in one example comprises a charging gateway component that selects a billing system component, to handle a charging data record, from a plurality of available billing system components based on one or more characteristics of the charging data record.

Another embodiment of the invention encompasses a method. One or more characteristics of a charging data record are identified through analysis of one or more content portions of the charging data record. The one or more characteristics of the charging data record are employed to route the charging data record to a billing system component of a plurality of available billing system components.

Yet another embodiment of the invention encompasses an article. The article comprises one or more computer-readable signal-bearing media. The article comprises means in the one or more media for identifying one or more characteristics of a charging data record through analysis of one or more content portions of the charging data record. The article comprises means in the one or more media for employing the one or more characteristics of the charging data record to route the charging data record to a billing system component of a plurality of available billing system components.

### DESCRIPTION OF THE DRAWINGS

Features of exemplary implementations of the invention will become apparent from the description, the claims, and the accompanying drawings in which:

FIG. 1 is a representation of an exemplary implementation of an apparatus that comprises one or more charging gateway components, a plurality of billing system components, and one or more data nodes.

FIG. 2 is a representation of an exemplary implementation of one or more processors, a plurality of pre-transfer file directories, and a plurality of post-transfer file directories of the charging gateway component of the apparatus of FIG. 1.

FIG. 3 is a representation of an exemplary implementation of one or more storage components, one or more storage component monitors, one or more file management components, and one or more gateway link management components of the charging gateway component of the apparatus of FIG. 1.

### DETAILED DESCRIPTION

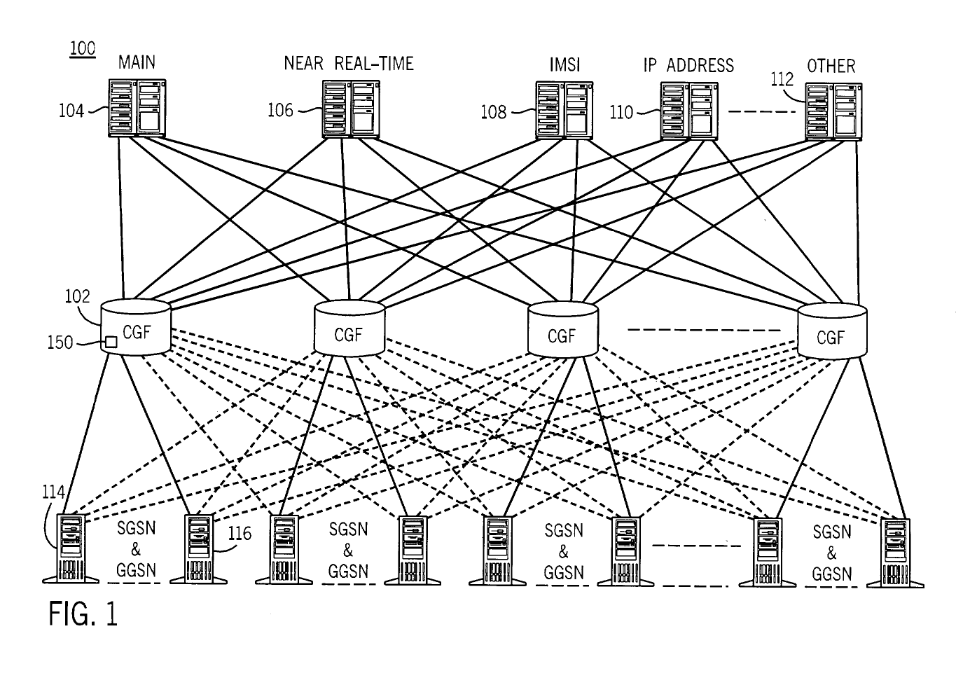

Turning to FIG. 1, an apparatus 100 in one example comprises a plurality of components such as computer software and/or hardware components. A number of such components can be combined or divided in the apparatus 100. An exemplary component of the apparatus 100 employs and/or comprises a set and/or series of computer instructions written in or implemented with any of a number of programming languages, as will be appreciated by those skilled in the art.

The apparatus 100 in one example comprises one or more charging gateway components 102, a plurality of billing system components 104, 106, 108, 110, and 112, and one or more data nodes, for example, data nodes 114 and 116.

In one example, the charging gateway component 102 comprises a charging gateway facility (“CGF”) of a universal mobile telecommunications system (“UMTS”) network. The charging gateway component 102 comprises an interface between the billing system components 104, 106, 108, 110, and 112 and the data nodes 114 and 116. For example, the data node 114 generates a charging data record and sends the charging data record to the charging gateway component 102. The charging gateway component 102 routes the charging data record to one of the billing system components 104, 106, 108, 110, and 112 based on one or more characteristics of the charging data record and/or the billing system components 104, 106, 108, 110, and 112.

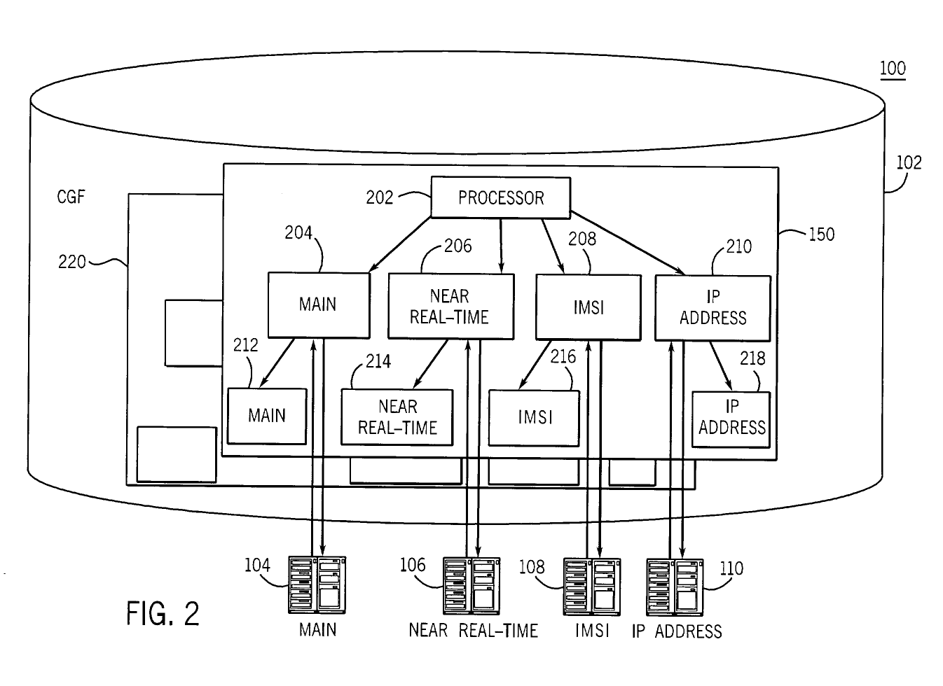

Turning to FIG. 2, the charging gateway component 102 in one example comprises one or more processors 202, a plurality of pre-transfer file directories 204, 206, 208, and 210, and a plurality of post-transfer file directories 212, 214, 216, and 218. The charging gateway component 102 comprises a backup copy 220 of the contents of the processor 202, the pre-transfer file directories 204, 206, 208, and 210, and the post-transfer file directories 212, 214, 216, and 218 to increase the reliability of the charging gateway component 102. The contents are duplicated at a high frequency to the backup copy 220 to maintain an exact replica of the processor 202, the pre-transfer file directories 204, 206, 208, and 210, and the post-transfer file directories 212, 214, 216, and 218.

The processor 202 in one example controls a distribution of charging data records to the pre-transfer file directories 204, 206, 208, and 210. The pre-transfer file directories 204, 206, 208, and 210 store charging data records that have yet to be processed by the billing system components 104, 106, 108, and 110. Once the billing system components 104, 106, 108, and 110 process the charging data records, then the post-transfer file directories 212, 214, 216, and 218 store the charging data records. For example, the pre-transfer file directory 204 stores a charging data record that is unprocessed by the billing system component 104. Once the billing system component 104 accesses and processes the charging data record, the charging data record is stored in the post-transfer file directory 212.

In one example, the charging gateway component 102 selects the billing system component 106, to handle the charging data record, from the billing system components 104, 106, 108, 110, and 112 based on one or more characteristics of the charging data record. For example, the charging data record comprises an indication for expedited service. To route the charging data record to the billing system component 106 the charging gateway component 102 concatenates the charging data record with other charging data records destined for the billing system component 106 into a charging data record file. The processor 202 sends the charging data record to the pre-transfer file directory 206 that is associated with the billing system component 106. The billing system component 106 in one example services charging data records faster than the billing system components 104, 108, and 110. For example, the billing system component 106 accesses the charging data records in the pre-transfer file directory 206 more frequently than the billing system components 104, 108, and 110 access the pre-transfer file directories 204, 208, and 210, respectively.

The charging gateway component 102 may employ other characteristics of the charging data record to select a billing system component, to handle the charging data record, from the billing system components 104, 106, 108, 110, and 112. The other characteristics in one example comprise origination from a particular data node or set of data nodes and involvement of a particular mobile station or set of mobile stations. In one example, an operator conducts a test on the particular data node or set of data nodes. Therefore, the charging gateway component 102 routes charging data records generated by the particular data node or set of data nodes to a particular billing system component that participates in the test. In another example, the operator tracks the activity of the particular mobile station or set of mobile stations. Therefore, the charging gateway component 102 routes charging data records that involve the particular mobile station or set of mobile stations to a particular billing system component that tracks the activity of the particular mobile station or set of mobile stations. For example, the operator may collect market research data on a group of mobile station users by routing the charging data records that involve a mobile station user of the group of mobile station users to the particular billing system component.

The pre-transfer file directories 204, 206, 208, and 210 specialize in temporary storage of charging data records of specific classifications. The specific classifications of the charging data records stored in the pre-transfer file directories 204, 206, 208, and 210 correspond to a provision of service to the charging data records of the specific classifications by the billing system components 104, 106, 108, and 110, respectively. For example, the pre-transfer file directory 204 and the billing system component 104 process charging data records that fall into a general category and do not comprise characteristics of other specific classifications (e.g., main service). The pre-transfer file directory 206 and the billing system component 106 process charging data records that request expedited service (e.g., near real-time service). The pre-transfer file directory 208 and the billing system component 108 process charging data records that indicate involvement of a mobile station or set of mobile stations with a set of particular international mobile subscriber identifications (e.g., IMSI service). The pre-transfer file directory 210 and the billing system component 110 processes charging data records that originate from a data node or set of data nodes with a set of particular internet protocol addresses (e.g., IP address service). The billing system component 112 processes charging data records that comprise one or more other characteristics that the charging gateway component 102 may employ to classify the charging data records.

Referring to FIG. 1, the billing system components 104, 106, 108, 110, and 112 process charging data records generated by the data nodes 114 and 116. In one example, the billing system components 104, 106, 108, 110, and 112 comprise billing mediation devices. The billing system components 104, 106, 108, 110, and 112 employ a file transfer protocol (“FTP”) interface to access the charging data records stored within the charging gateway component 102. The billing system components 104, 106, 108, 110, and 112 generate bills based on the information contained within the charging data records. In one example, the billing system components 104, 106, 108, 110, and 112 specialize in a provision of service to charging data records of specific classifications. For example, the charging gateway component 102 selects a billing system component, to handle the charging data record, that provides service to a charging data record of a specific classification. The charging gateway component 102 selects the billing system component from the billing system components 104, 106, 108, 110, and 112 based on one or more characteristics of the billing system component. For example, the one or more characteristics are based on the provision of service to charging data records of different classifications.

The data nodes 114 and 116 generate charging data records in response to an occurrence of a billable event in a packet network (e.g., a data transfer that involves a user of the packet network). The data nodes 114 and 116 in one example comprise one or more of a serving general packet radio service support node (“SGSN”) and a gateway general packet radio service support node (“GGSN”). The data nodes 114 and 116 gather information of the data transfer to include in the charging data record. For example, the charging data record includes an indication of the quantity of data transferred and/or the time duration of the data transfer. The charging data record closes upon occurrence of a charging data record closure event (e.g., a predetermined quantity of data has been transferred and/or a predetermined time duration of the data transfer has been reached). Once the charging data record closes, the data nodes 114 and 116 send the charging data record to the charging gateway component 102.

Referring to FIGS. 1 and 2, an illustrative description of an exemplary operation of the apparatus 100 is now presented, for explanatory purposes. An operator of the charging gateway component 102 may provision one or more criteria for the charging gateway component 102. The charging gateway component 102 employs the one or more criteria to select one or more characteristics from a set of characteristics of a charging data record for employment in a selection of a billing system component, to handle the charging data record, from the billing system components 104, 106, 108, 110, and 112.

The data node 114 generates a first charging data record in response to a first billable event that involves a first mobile station. The data node 114 sends the first charging data record to the charging gateway component 102. The data node 116 generates a second charging data record in response to a second billable event that involves a second mobile station. The second charging data record comprises an indication of a request for expedited service. The data node 116 sends the second charging data record to the charging gateway component 102.

The charging gateway component 102 may categorize the first charging data record and the second charging data record based on one or more of the characteristics of the first charging data record and the second charging data record. For example, the charging gateway component 102 may categorize the first charging data record by one of an indication that the first charging data record was generated at the data node 114 and an indication of the involvement of the first mobile station in the first billable event. The charging gateway component 102 may categorize the second charging data record by one of an indication that the second charging data record was generated at the data node 116, an indication of the involvement of the second mobile station in the second billable event, and an indication of the request for expedited service of the second charging data record.

In one example, the operator of the charging gateway component 102 provisions the one or more criteria to trigger the charging gateway component 102 to search for charging data records generated at one or more specific data nodes (e.g., the data node 114 and/or the data node 116). Upon receipt of the first charging data record, the charging gateway component 102 examines a content portion (e.g., a header field) of the first charging data record that comprises an indication of the data node (e.g., the data node 114) that generated the first charging data record. If the operator provisions the charging gateway component 102 to search for charging data records generated at the data node 114, then the charging gateway component 102 routes the first charging data record to the pre-transfer file directory 210 that is accessed by the billing system component 110. For example, the operator specifies a set of internet protocol addresses of data nodes. The charging gateway component 102 compares the internet protocol address found in the header field of the first charging data record with the set. If the internet protocol address found in the header field matches an internet protocol address in the set, then the charging gateway component 102 routes the first charging data record to the pre-transfer file directory 210.

In another example, the operator of the charging gateway component 102 provisions the one or more criteria to trigger the charging gateway component 102 to search for charging data records that are generated in response to a billable event that involves one or more specific mobile stations (e.g., the first mobile station and/or the second mobile station). Upon receipt of the first charging data record, the charging gateway component 102 examines a content portion of the first charging data record that comprises an indication of the mobile station (e.g., the first mobile station) that was involved with the billable event that generated the first charging data record. If the operator provisions the charging gateway component 102 to search for charging data records generated in response to the billable event that involves the first mobile station, then the charging gateway component 102 routes the first charging data record to the pre-transfer file directory 208 that is accessed by the billing system component 108. In one example, the operator specifies a set of international mobile subscriber identifications of mobile stations and the charging gateway component 102 compares the international mobile subscriber identification found in the content portion of the first charging data record with the set. If the international mobile subscriber identification found in the content portion matches an international mobile subscriber identification in the set, then the charging gateway component 102 routes the first charging data record to the pre-transfer file directory 208.

In yet another example, the operator of the charging gateway component 102 provisions the one or more criteria to trigger the charging gateway component 102 to search for charging data records that request expedited service. Upon receipt of the second charging data record, the charging gateway component 102 examines a content portion of the second charging data record that comprises an indication of the request for expedited service. For example, the second charging data record comprises an activated hot billing indicator or an H-flag. If the operator provisions the charging gateway component 102 to search for charging data records that request expedited service, then the charging gateway component 102 routes the second charging data record to the pre-transfer file directory 206 that is accessed by the billing system component 106.

The operator in one example does not provision the charging gateway component 102 to search for charging data records that comprise the one or more characteristics of the first charging data record or the second charging data record. Therefore, the charging gateway component 102 routes the first charging data record and the second charging data record by default to the pre-transfer file directory 204 that is accessed by the billing system component 104.

Additional data nodes send charging data records to the charging gateway component 102 and/or additional charging gateway components analogously to the data nodes 114 and 116 sending charging data records to the charging gateway component 102, as described above. Additional charging gateway components route charging data records to the billing system components 104, 106, 108, 110, and 112 analogously to the charging gateway component 102 routing charging data records to the billing system components 104, 106, 108, 110, and 112, as described above.

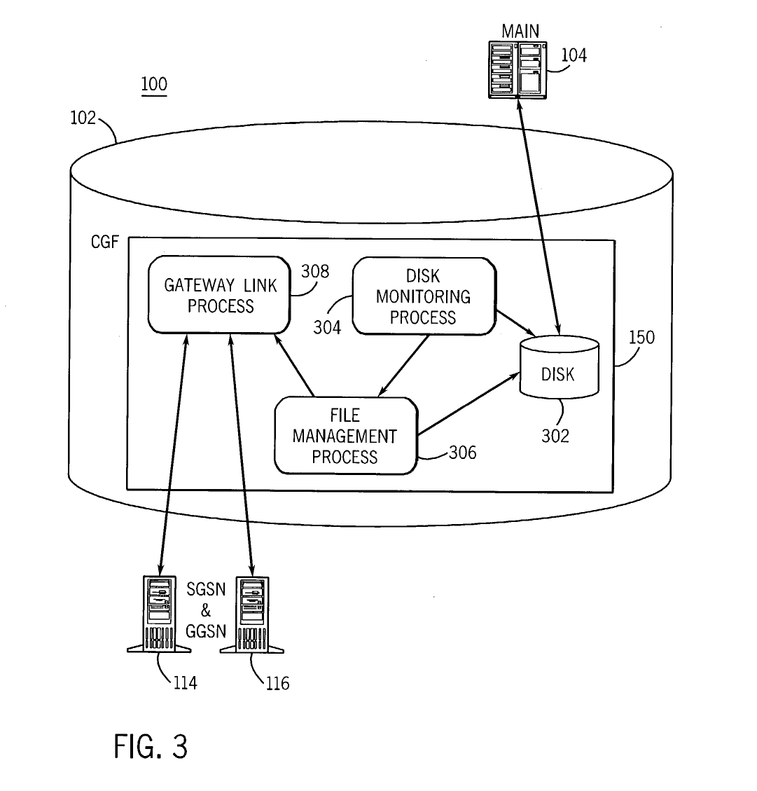

Turning to FIG. 3, the data nodes 114 and 116 generate and send charging data records to the charging gateway component 102. The charging gateway component 102 in one example stores and then routes the charging data records to the billing system component 104. If storage space within the charging gateway component 102 is full, then the charging gateway component 102 is unable to accept additional charging data records from the data nodes 114 and 116. The storage space within the charging gateway component 102 may become full if the charging data records are unable to pass from the charging gateway component 102 to the billing system component 104. For example, if a network outage or failure occurs between the charging gateway component 102 and the billing system component 104, then the charging gateway component 102 is unable to route the charging data records to the billing system component 104.

The charging gateway component 102 in one example comprises one or more storage components 302, one or more storage component monitors 304, one or more file management components 306, and one or more gateway link management components 308. The storage component 302 comprises a storage capacity. The storage component 302 holds one or more first charging data records that have yet to be processed by the billing system component 104 and one or more second charging data records that have been processed by the billing system component 104. The storage component monitor 304 detects an available capacity for additional charging data records in the storage component 302. The storage component monitor 304 determines when the available capacity of the storage component 302 reaches a threshold level (e.g., one or more of a high water mark, a low water mark, and a storage full mark). Upon detection by the storage component monitor 304 of the available capacity below the threshold level, the storage component monitor 304 sends an indication of the available capacity to the file management component 306. Upon receipt of the indication from the storage component monitor 304, the file management component 306 clears a portion of the storage component 302 to accommodate additional charging data records.

The file management component 306 determines a time of creation for the one or more second charging data records. Upon the indication from the storage component monitor 304, the file management component 306 deletes one or more charging data records of the one or more second charging data records that were created before a predetermined time. The predetermined time in one example is set by an operator of the charging gateway component 102. After the file management component 306 deletes the one or more charging data records that were created before the predetermined time and the available capacity falls below the threshold level, the charging gateway component 102 sends an alarm to notify an operations, administration, and management (“OA&M”) component and the file management component 306 deletes one or more charging data records of the one or more second charging data records that were created since the predetermined time.

The file management component 306 deletes the one or more charging data records in an order from a longest time since creation to a shortest time since creation. The file management component 306 continues deletion of the one or more second charging data records until all of the one or more second charging data records have been deleted or until the available capacity is above the threshold level. For example, the file management component 306 terminates the deletion of the one or more second charging data records when the available capacity reaches the threshold level plus ten percent of the total capacity of the storage component 302.

If the storage component 302 becomes full and unable to accept another charging data record, then the file management component 306 notifies the gateway link management component 308 to reject any charging data records that attempt to enter the charging gateway component 102 from the data nodes 114 and 116. For example, the gateway link management component 308 notifies the data nodes 114 and 116 that the charging gateway component 102 does not have any resources available to store any additional charging data records. The charging gateway component 102 sends an alarm to notify the operations, administration, and management component that the storage component 302 is full.

The apparatus 100 in one example employs one or more computer-readable signal-bearing media. One example of a computer-readable signal-bearing medium for the apparatus 100 comprises an instance of a recordable data storage medium 150 such as one or more of a magnetic, electrical, optical, biological, and atomic data storage medium. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a charging gateway component that selects a billing system component, to handle a charging data record, from a plurality of available billing system components based on one or more characteristics of the charging data record.

2. The apparatus of claim 1, wherein the charging data record comprises a first charging data record, wherein the billing system component comprises a first billing system component;
wherein the charging gateway component selects a second billing system component, to handle a second charging data record, from the plurality of available billing system components based on one or more characteristics of the second charging data record;
wherein the one or more characteristics of the second charging data record are different than the one or more characteristics of the first charging data record, wherein the second billing system component is different from the first billing system component.

3. The apparatus of claim 1, wherein the charging gateway component selects the billing system component, to handle the charging data record, from the plurality of available billing system components based on an indication of a request for expedited service of the charging data record.

4. The apparatus of claim 3, wherein based on the indication of the request for expedited service and a provision of expedited service by the billing system component, the charging gateway component selects the billing system component, to handle the charging data record, from the plurality of available billing system components.

5. The apparatus of claim 1, wherein upon occurrence of one or more billable events, a data node executes a generation of one or more charging data records that comprise the charging data record, wherein the data node sends the charging data record to the charging gateway component;
wherein the one or more characteristics of the one or more charging data records comprise an indication to the charging gateway component of the generation by the data node of the charging data record;
wherein based on the indication of the generation by the data node of the charging data record and a provision of service by the billing system component to the one or more charging data records generated by the data node, the charging gateway component selects the billing system component, to handle the charging data record, from the plurality of available billing system components.

6. The apparatus of claim 1, wherein upon occurrence of one or more billable events that comprise an involvement of one or more mobile stations, a data node executes a generation of one or more charging data records that comprise the charging data record, wherein the data node sends the charging data record to the charging gateway component;
wherein the one or more characteristics of the one or more charging data records comprise an indication of the involvement by the one or more mobile stations in the billable event;
wherein based on the indication of the involvement by the one or more mobile stations and a provision of service by the billing system component to the one or more charging data records that comprise the indication of the involvement by the one or more mobile stations, the charging gateway component selects the billing system component, to handle the charging data record, from the plurality of available billing system components.

7. The apparatus of claim 1, wherein upon an occurrence of a billable event, a data node generates the charging data record, wherein the data node sends the charging data record to the charging gateway component;
wherein the charging gateway component analyzes one or more content portions of the charging data record to identify the one or more characteristics of the charging data record.

8. The apparatus of claim 1, wherein the charging gateway component comprises a plurality of directories, wherein the plurality of available billing system components access the plurality of directories, respectively;
wherein the charging gateway component establishes a classification of the charging data record based on one or more of the one or more characteristics of the charging data record;
wherein based on the classification the charging gateway component selects a directory from the plurality of directories to store the charging data record.

9. The apparatus of claim 1, wherein an operator of the charging gateway component provisions one or more criteria for the charging gateway component, wherein the charging gateway component employs the one or more criteria to select the one or more characteristics from a set of characteristics of the charging data record for employment in a selection of the billing system component from the plurality of available billing system components.

10. The apparatus of claim 1, wherein the charging gateway component comprises a storage component that comprises a storage capacity, wherein the storage component holds one or more first charging data records that have yet to be processed by one or more of the plurality of available billing system components and one or more second charging data records that have been processed by one or more of the plurality of available billing system components;
wherein the charging gateway component monitors an available capacity of the storage capacity for additional charging data records that have yet to be processed by one or more of the plurality of available billing system components, wherein upon a determination by the charging gateway component that the available capacity is below a threshold level, the charging gateway component clears a portion of the storage capacity of the storage component for accommodation of the additional charging data records.

11. The apparatus of claim 10, wherein the charging gateway component determines a time of creation for the one or more second charging data records;
wherein upon the determination by the charging gateway component that the available capacity is below the threshold level, the charging gateway component deletes one or more of the one or more second charging data records in an order of longest time since creation to shortest time since creation until the available capacity is above the threshold level.

12. A method, comprising the steps of:
identifying one or more characteristics of a charging data record through analysis of one or more content portions of the charging data record; and
employing the one or more characteristics of the charging data record to route the charging data record to a billing system component of a plurality of available billing system components.

13. The method of claim 12, wherein a content portion of the one or more content portions of the charging data comprises an indication of a request for expedited service, wherein the step of employing the one or more characteristics of the charging data record to route the charging data record to the billing system component of the plurality of available billing system components comprises the steps of:
matching the charging data record that comprises the indication of the request for expedited service with the billing system component that comprises a provision of expedited service; and
routing the charging data record to the billing system component based on the match between the indication of the request for expedited service and the provision of expedited service.

14. The method of claim 12, wherein a data node executes a generation of one or more charging data records that comprise the charging data record, wherein a content portion of the one or more content portions of the charging data record comprises an indication of the data node, wherein the step of employing the one or more characteristics of the charging data record to route the charging data record to the billing system component of the plurality of available billing system components comprises the steps of:
matching the charging data record that comprises the indication of the data node with the billing system component that comprises a provision of service to the one or more charging data records generated by the data node; and
routing the charging data record to the billing system component based on the match between the indication of the data node and the provision of service to the one or more charging data records generated by the data node.

15. The method of claim 12, wherein upon occurrence of one or more billable events that comprise an involvement of one or more mobile stations, a data node executes a generation of one or more charging data records that comprise the charging data record, wherein a content portion of the one or more content portions of the charging data record comprises an indication of the involvement of the one or more mobile stations, wherein the step of employing the one or more characteristics of the charging data record to route the charging data record to the billing system component of the plurality of available billing system components comprises the steps of:
matching the charging data record that comprises the indication of the involvement of the one or more mobile stations with the billing system component that comprises a provision of service to the one or more charging data records; and
routing the charging data record to the billing system component based on the match between the indication of the involvement of the one or more mobile stations and the provision of service to the one or more charging data records.

16. The method of claim 12, wherein the plurality of available billing system components access a plurality of directories, respectively, wherein the step of employing the one or more characteristics of the charging data record to route the charging data record to the billing system component of the plurality of available billing system components comprises the steps of:
establishing a classification of the charging data record based on the one or more characteristics of the charging data record;
matching the charging data record that comprises the classification with the a directory of the plurality of directories that comprises a provision of storage to the charging data record that comprises the classification; and
routing the charging data record to the directory based on the classification of the charging data record and the provision of storage to the charging data record that comprises the classification.

17. The method of claim 12, wherein an operator provisions one or more criteria for a charging gateway component to route the charging data record to the billing system component of the plurality of available billing system components, wherein the step of employing the one or more characteristics of the charging data record to route the charging data record to the billing system component of the plurality of available billing system components comprises the step of:
employing the one or more criteria to select the one or more characteristics from a set of characteristics of the charging data record to route the charging data record to the billing system component of the plurality of available billing system components.

18. The method of claim 12, wherein the charging data record comprises a first charging data record, wherein the billing system component comprises a first billing system component, further comprising the steps of:
identifying one or more characteristics of a second charging data record through analysis of one or more content portions of the second charging data record; and
employing the one or more characteristics of the second charging data record to route the second charging data record to a second billing system component of the plurality of available billing system components, wherein the one or more characteristics of the second charging data record are different than the one or more characteristics of the first charging data record, wherein the second billing system component is different from the first billing system component.

19. The method of claim 12, wherein a charging gateway component comprises a storage component that comprises a storage capacity, wherein the storage component holds one or more first charging data records that have yet to be processed by one or more of the plurality of available billing system components and one or more second charging data records that have been processed by one or more of the plurality of available billing system components, further comprising the steps of:
monitoring an available capacity of the storage capacity for additional charging data records that have yet to be processed by one or more of the plurality of available billing system components; and
deleting one or more of the one or more second charging data records, upon determination by the charging gateway component that the available capacity is below a threshold level, in an order of longest time since creation to shortest time since creation until the available capacity is above the threshold level.

20. An article, comprising:
one or more computer-readable signal-bearing media;
means in the one or more media for identifying one or more characteristics of a charging data record through analysis of one or more content portions of the charging data record; and
means in the one or more media for employing the one or more characteristics of the charging data record to route the charging data record to a billing system component of a plurality of available billing system components.
